(19) United States
(12) Patent Application Publication
(10) Pub. No.: US 2013/0211899 A1
(43) Pub. Date: Aug. 15, 2013

(54) CONSUMER PROMOTION MANAGEMENT SYSTEM

(71) Applicant: MyMedCoupons, LLC, (US)

(72) Inventors: Vidhu Nagpal, Murrysville, PA (US); Anup Kaneri, Sewickley, PA (US)

(73) Assignee: MYMEDCOUPONS, LLC, Pittsburgh, PA (US)

(21) Appl. No.: 13/761,502

(22) Filed: Feb. 7, 2013

Related U.S. Application Data
(60) Provisional application No. 61/597,443, filed on Feb. 10, 2012.

(51) Int. Cl. G06Q 30/02

(52) U.S. Cl. CPC G06Q 30/0257
USPC 705/14.25

(57) ABSTRACT

A retail promotion management system presents a consumer with a set of retail promotions. The consumer selects a set of retail promotions to store in the consumer's account. When the consumer makes a purchase, the consumer provides the system with retail store receipt data, which will includes information indicating that the consumer has purchased the promoted product. The system verifies the transaction and then issues a reward to the consumer, based on the retail promotion. Sellers also may upload retail promotions to the system for presentation to the consumer as candidate promotions.

### RELATED APPLICATIONS AND CLAIM OF PRIORITY

This patent document claims priority to U.S. Provisional Patent Application No. 61/597,443, filed Feb. 10, 2012, the disclosure of which is fully incorporated herein by reference.

### BACKGROUND

Couponing is a well-known marketing tool that brand owners and retailers use to promote their products and services. With the advent of online coupon and gift certificate purchase websites, consumers have become more frugal and, consequently, more coupon-centric.

The most common form of coupon distribution is that of free-standing inserts that are printed in newspapers, coupon booklets, and the like. However, free-standing inserts have limited reach and are expensive to distribute to end users. In addition, the redemption process for free-standing inserts is inconvenient, as the consumer must remember to carry the coupons when they stop at the store for shopping. Thus, free-standing inserts have a low redemption rate.

Some retailers have implemented online promotional methods, such as that of grocery store loyalty card systems that allow consumers to load coupons into their store loyalty card accounts. The coupons may be automatically redeemed when the consumer presents his or her loyalty card at checkout. However, these systems are retailer-specific. Smaller stores such as individually-owned businesses often cannot justify the investment in such a large-scale loyalty card system. In addition, product manufacturers must negotiate coupon deals with each retailer to ensure that the manufacturer's coupon can be used with an electronic loyalty card system.

This document describes systems and methods that provide solutions to some or all of the problems described above, and that may provide additional benefits.

### SUMMARY

In an embodiment, a retail promotion management system may use a clearinghouse portal to present a consumer with a set of offered retail promotions. The system receives, from the consumer via a communications network, a selected set of the retail promotions. Each of the retail promotions corresponds to a promoted product. The system stores, in a clearinghouse database, the selected retail promotions in association with an identifier for the consumer. The system also receives retail store receipt data from the consumer. The retail store receipt data includes information indicating that the consumer has purchased a product. The system uses a processor to analyze the retail store receipt data to identify the purchased product. The system accesses the clearinghouse database to identify a promoted product that corresponds to the purchased product, along with a retail promotion that is associated with the identified promoted product. The system then issues a reward to the consumer. The reward has a value that is determined by the retail promotion.

In some embodiments, the system may receive, from a seller of one of the promoted products, the retail promotion that corresponds to the seller's promoted product. If so, it will store the received retail promotion in a computer-readable memory.

### BRIEF DESCRIPTION OF THE FIGURES

FIG. 1 is a front view of an example of an electronic device that may be used by a consumer to make a retail purchase.

FIG. 2 is a rear view of the device of FIG. 1.

FIG. 3 is a block diagram illustrating various elements of an embodiment of a reward redemption system.

FIG. 4 is a block diagram illustrating various elements of an embodiment of a reward redemption method.

FIG. 5 is a block diagram showing elements of a computing device that may be used in accordance with various embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

An “electronic device” refers to a device that includes a processor and tangible, computer-readable memory. The memory may contain programming instructions in the form of a software application that, when executed by the processor, causes the device to perform one or more operations according to the programming instructions. Examples of suitable devices include portable electronic devices such as smartphones, personal digital assistants, cameras, tablet devices, electronic readers, personal computers, media players, satellite navigation devices and the like.

An “imaging device” refers to any device capable of optically viewing an object and converting an interpretation of that object into electronic signals. One such example of an imaging device is a camera lens.

For the purposes of this document, a “retail promotion” is an offer by a manufacturer or distributor of a product or by another entity to a consumer who purchases the product. A retail promotion may be, for example, an agreement to rebate a portion of the consumer's purchase price, an agreement to provide the consumer with a credit or coupon that may be used toward a future purchase, a free or discounted product to be provided after the purchase, a rebate, or similar incentives. The term “product” includes any product or service that is offered to, and purchasable by, a retail consumer. Examples of products may include groceries at a grocery store, prescription drugs at a retail pharmacy, or services that are provided to individual consumers, such as gym memberships or fitness classes. In the embodiments disclosed below, at least some of the products will be available from multiple retail outlets, so that the consumer's purchase options are not limited to a single retailer.

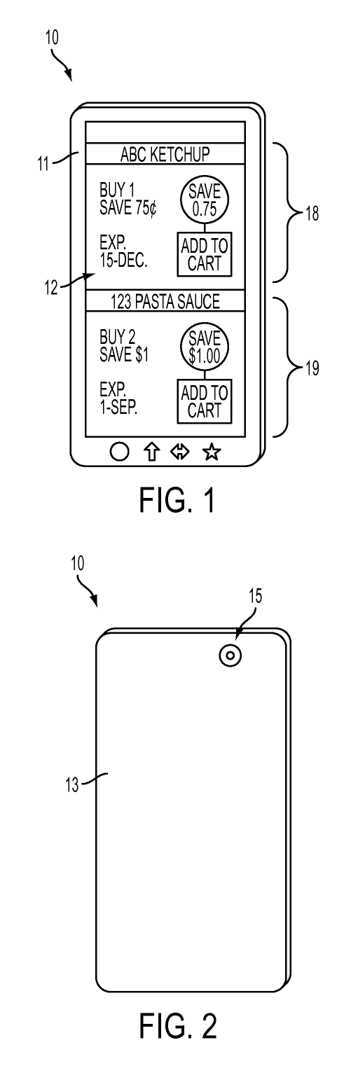

FIG. 1 shows one example of an electronic device 10. The electronic device 10 may include a front face 11 and a display 12. The display 12 may be any suitable component for displaying images, including, but not limited to, an electroluminescent display, an electronic paper display, a vacuum fluorescent display, a light emitting diode (LED) display, a cathode ray tube (CRT) display, a liquid crystal (LCD) display, a plasma display panel, a digital light processing (DLP) display, and an organic light-emitting diode (OLED) display. The display 12 may also include a touch sensitive screen, including, but not limited to, resistive touchscreens, capacitive touchscreens, and infrared touchscreens.

FIG. 2 shows a rear face 13 of the electronic device 10. The rear face 13 may include an imaging device 15. The imaging device 15 may be any suitable component capable of receiving an optical image and transmitting the information to other components for processing. The imaging device may have an ability to adjust its focal length and aperture in such a manner that would allow it to zoom and properly focus upon an intended object to be imaged. This adjustment may define an optimal focal distance, or a range of distances in which the electronic device 10 may be properly positioned from the intended object to be imaged to achieve a clear image.

While the imaging device 15 is depicted on the rear face of the present example, persons skilled in the art will appreciate that the imaging device 15 may be positioned at any location upon any face of the electronic device 10, or may even be external to the electronic device 10 and connected by any means of electronic communication, including, but not limited to, physical cable communication such as universal serial bus (USB), wireless radio communication, wireless light communication, or near field communication technology.

In some embodiments, the display 12 may be positioned within the electronic device 10, and may be configured in such a way so as to display the output of the imaging device 15 in real time so that the user may view the display 12 and see the output of the imaging device 15 on the display.

Accordingly, the configuration of the electronic device 10 as shown in FIGS. 1 and 2 is only an example, and persons skilled in the art will appreciate other configurations that are able to achieve a similar overall result.

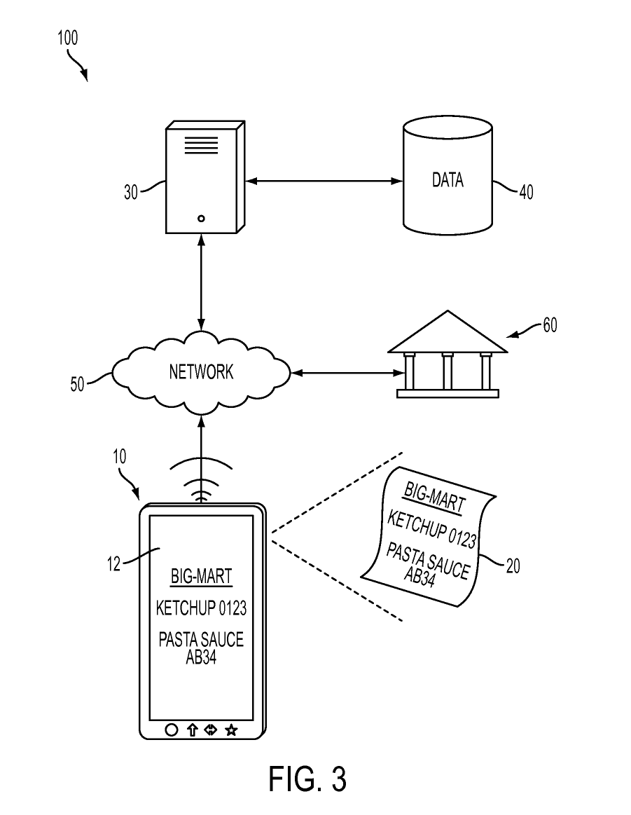

FIG. 3 illustrates an example of a system 100 that may be used to implement a retail promotion management system. The consumer may use the electronic device 10 to request that the server 30 provide the consumer with information about available retail promotions. The server may obtain the available retail promotions from a promotion clearinghouse's data store 40 and deliver the promotions to the consumer via a communications network 50. The consumer may then select available promotions and add them to the consumer's account before making a retail purchase. For example, referring again to FIG. 1, the system may display multiple retail promotions 18, 19 to the user, and the user may select which promotions he or she wishes to add to his or her account. Referring back to FIG. 3, the consumer-selected promotions may be stored in the consumer's account, either on a memory of the electronic device 10, or in the data store 40, or in both locations. The consumer's account will include a consumer-specific identifier that uniquely identifies the consumer. Thus, the selected promotions will be stored in the account in association with the consumer-specific identifier.

When a consumer makes a retail purchase, the seller or another entity will issue a purchase receipt 20 to the consumer. The receipt 20 will include data indicating one or more products that have been purchased at a retail store. The data will include product identification such as a stock-keeping unit (SKU) code, a barcode, a quick response (QR) code, or other indicia identifying the product. Optionally, the receipt also may include additional data as will be described below. A purchase receipt 20 is physical or electronic proof of purchase provided to the consumer. The receipt 20 may be a printed receipt as shown, or it may be an electronic file containing proof of purchase data.

The consumer may use the portable electronic device 10 to obtain data from the retail purchase receipt 20. For example, if the purchase receipt is a printed receipt, the consumer may use the device to capture an image of the receipt. The image may be captured by a camera, scanner, or other imaging hardware that is used with the portable electronic device as shown in FIG. 3. The electronic device may output the image on the device's display 11 so that the device's user can verify that all necessary data has been captured in the image. Alternatively, user's device may receive the image or proof or purchase data as an electronic data file, such as by email, text message or other communications methods. For example, the user may provide the retailer with a clearinghouse email address to delivery of an e-receipt, or the consumer may forward the e-receipt to that address. Alternatively, the electronic device may use near field communications to accept a digital receipt for the consumer, and the device may then upload the data to the clearinghouse. As yet another option, the consumer may authorize the clearinghouse to get the receipt data from the consumer's credit card issuer or from the issuer of another financial transaction card or token. If so, the device may send a request to the credit card issuer to receive such data, and it may use the data when receive. Or, the device may automatically receive such data in a credit account statement that is periodically issued by the financial card issuer.

The receipt data may be analyzed by a software application of the electronic device to extract data indicating that the consumer has purchased the retail product, and the data may be transmitted to a clearinghouse server 30 via one or more communications networks 50 such as a mobile telephone network, the Internet, or other networks. Alternatively, the receipt data may be transmitted to the clearinghouse server 30, which will analyze the file and extract the relevant data. The server 30 may compare the extracted data with stored data that is housed in a data store 40, such as one or more databases that contain data relating to retail promotions that the user has selected for his or her account.

If the extracted data matches stored data relating to a promotion that has been added to the consumer's account, the server 30 may cause the consumer to receive the promotion. For example, the server 30 transmit a message to a financial custodian 60 for the consumer. The financial custodian 60 may be an entity that manages an account for the consumer, such as a bank, credit card or debit card issuer, or similar institution. Alternatively, the financial custodian 60 may be an entity that creates and issues an instrument having financial value to the consumer, such as a check issuer, a gift card issuer, or a coupon issuer.

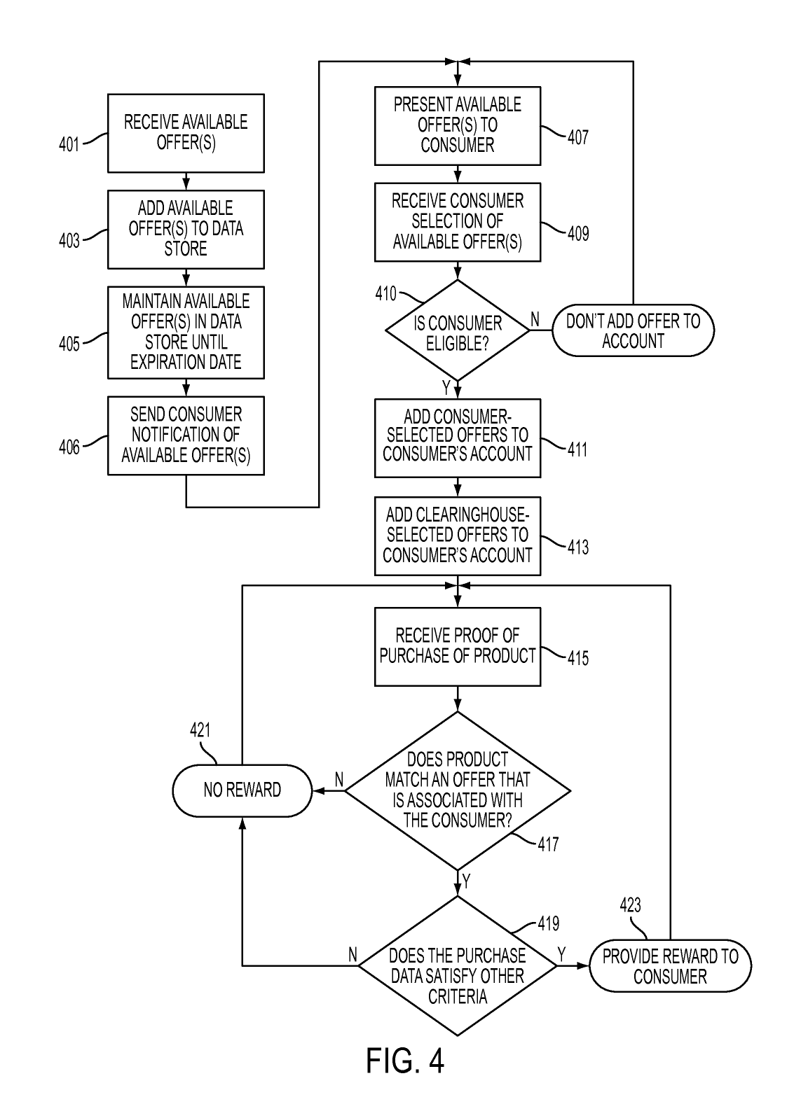

FIG. 4 is a flowchart that depicts various steps of a retail promotion management process. The management system may provide a product seller, such as a distributor or brand owner, with an online portal, such as a website or a software application, in which the seller may enter data relating to a retail promotion. The data may include information such as:
Product name
Product category
Product image
Product size
Product SKU
Series number
Promotion start date
Promotion end date for purchase
Promotion end date for reward redemption
Total coupons available
Reward/rebate/coupon value
Search keywords
Redemption keywords
Limit per customer
Coupon geographic data (e.g., ZIP codes, states)

The system may collect this information via various input fields, drop-down menus, keypads, or other user interface means.

When the system receives promotional offers from the seller 401, it will add the offers to the data store as available offers 403 and maintain the offers in the data store 405 until at least the purchase end date or the redemption end date 405. The data store will house multiple promotions from multiple sellers, representing a variety of products and brands, without a requirement that all promotions be purchased at a particular store or stores. As used in this document, a “seller” refers to a product manufacturer, a distributor, a provider of a service, a manufacturer's or service provider's representative, or another entity with a financial interest in promoting the product. Examples include food manufacturers, pharmaceutical manufacturers, tire manufacturers, physical fitness centers, membership organizations, or providers of other products and services and their representatives.

The consumer may access the system by an online portal, such as a web page, or via a software application that runs on an electronic device having communications capability, such as a smartphone or a computing device having a communications port that is connected to a communications network such as the Internet. The system presents the consumer with a set of available offers 407. The offers may be presented by various menus, in search results that are responsive to consumer search requests, or any other means. For example, a consumer may enter a type of item (e.g., cereal, or prescription drugs, or tires), and the system will identify and present a set of all available offers for that category of item. The system may determine available offers based on a comparison of the consumer's selected category with keywords in the database for products having offers. If multiple offers are possible, the coupons may be presented in a ranked order, such as by closest match, promoted or sponsored offers first, or based on the consumer's past purchase or coupon use history.

The consumer may select one or more of the offers 409, and the system will add the consumer's selections to the user's account 411. The server may organize the selections for the consumer as a shopping list. Optionally, the server may automatically add one or more clearinghouse-selected offers to the user's account 413. The clearinghouse-selected offers need not be affirmatively selected by the user, but rather may be added to the consumer's account based on an analysis of the consumer's previous reward selection history, based on specifications by the seller (such as “provide this coupon to all consumers having addresses in ZIP code 12345”), based on previous requests by the consumer for automatic addition of offers that satisfy consumer-specified criteria, or based on other criteria. The consumer's application may display the consumer-selected and/or clearinghouse-selected offers via one or more shopping lists.

Optionally, if a consumer has selected an available offer but not used it within a threshold period of time, or if an offer is available in the data store but not selected by the consumer within a threshold period of time, or when an offer is first made available in the data store, the system may send the consumer a notification 406 of the available offer. For example, this may occur when a new product or product offer is available. Alternatively, this may occur within a threshold period of time after the consumer's last purchase of the product. For example, if a consumer purchases a one-month supply of a prescription drug for which an offer is available, the system may send a notification twenty days after the first purchase. The notification may be done by any suitable process, such as a phone call or text message, an e-mail, or a notification when the user opens a software application. In addition, if the system is aware that a consumer is likely to purchase a product, such as because it has received information indicating that a physician has prescribed a medication, it may notify the consumer of a promotion for the medication.

Similarly, if the system has received information indicating that the consumer meets eligibility criteria, it may notify the consumer of available offers that are associated with the criteria 406. Eligibility criteria may include evidence of prior purchase of a product or service, membership in an organization (such as an alumni association or non-profit organization), subscription to a healthcare plan, or other criteria.

In some embodiments, before adding an offer to a consumer's account, the system will verify the consumer's eligibility to receive the offer 410. For example, the consumer may be required to verify a geographic location, to provide a proof of purchase of another product or service, to confirm membership in an organization, to provide an identification code or other evidence of participation in a healthcare plan, or other criteria.

When the system receives an indication that the consumer has purchased a product 415, it will determine whether the purchased product matches a product for which an offer is available in the consumer's account 417. Receiving the indication may occur after the consumer captures an image of the retail store receipt or otherwise receives proof of purchase data. The indication may include the image itself, or it may include data resulting from an image analysis that is performed by a software application that is running on the consumer's electronic device. For example, the electronic device may capture a digital image of the receipt, and the device may execute a software application that performs optical character recognition to look for one or more data points in the image. Suitable data points required for verification may include store name or number and store item number, a SKU code, or other validating information. Alternatively, the receipt data can be received as a digital file, such as via a PDF that the consumer uploads to the system, via a digital receipt that the retailer issues via e-mail, via text message, via a near-field communication such as a Bluetooth® transmission, or via a validation message whereby a transaction card provider verifies a purchase made by the consumer using the transaction card. If the data is received in electronic format and need not be scanned, any suitable programming instructions may be used to analyze the electronic data file to extract the proof of purchase data.

To determine whether the purchased product matches a product for which the consumer has selected an offer, the system compares data from the purchased product to available product offer data to determine whether the purchased product data matches any of the available product offer data and/or satisfies a threshold amount of criteria required for offer redemption. Examples of data points that may be collected include, but are not limited to:
Store name and/or logo
Store location
Transaction date
Names of items purchased
SKU(s) and/or store item number(s) of items purchased
Transaction code or identifier
Price of items purchased (total and/or individual)
Mode of payment
In case of credit or debit card, authorization code
Last 4 digits of credit or debit card

The system may use a ranked order for determining matches. In addition, it may require that the transaction satisfy other criteria 419, such as a requirement to purchase a related product or a minimum number of products, or a requirement that the transaction have occurred within a predetermined data range. For example, if an SKU number on the receipt matches that of a product in the available offer database, and if the purchase date is within the valid period of the available offer for that product, then the system may not need to look further, and the system may issue the reward to the consumer 423. If not, then the system may deny the reward 421 and will instead await the consumer's next actions. Other criteria may include data points such as:
All required data fields were captured on the receipt
Receipt validity is checked (such as by receiving verification from a credit card issuer, or by verifying the presence of one or more known landmarks on the receipt such as store logo
The consumer has added the offer to his or her account
The purchase transaction occurred on or after the promotion start date and before a promotion end date
The consumer redeemed the reward before the redemption end date for the promotion
SKU or store item number on receipt matches that in database for the product
Combination of store name and store item number or name matches with data in the database for the product
Price paid for the product is greater than or equal to the value of the reward
Credit card issuer has issued an authorization

Optionally, before providing the reward to the consumer, the system may verify that the transaction described on the retail receipt actually occurred. The system may do this by sending a verification request message to the consumer's credit card company or other financial institution and receiving a verification response relating to the transaction. The verification request message may include information such as retail store name and location, date of purchase, amount paid, transaction card number (or a portion thereof), and/or a transaction code. If the transaction card provider does not verify the transaction within a predetermined time period, or if the transaction card provider indicates that the transaction is not accurate, the system may deny the consumer a reward 421.

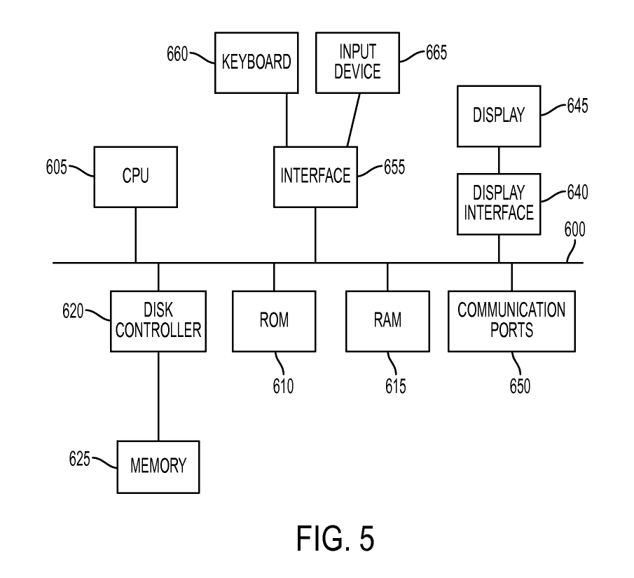

FIG. 5 depicts a block diagram of exemplary internal hardware that may be used to contain or implement program instructions, such as the process steps discussed above in reference to FIG. 4, according to embodiments. Any or all of the elements may be included in the consumer's electronic device and/or the clearinghouse server. A bus 600 serves as the main information highway interconnecting the other illustrated components of the hardware. CPU 605 is the central processing unit of the system, performing calculations and logic operations required to execute a program. CPU 605, alone or in conjunction with one or more of the other elements disclosed in FIG. 5 is an exemplary processing device, computing device or processor as such terms are used within this disclosure. Read only memory (ROM) 610 and random access memory (RAM) 615 constitute exemplary memory devices or processor-readable storage media.

A controller 620 interfaces with one or more optional tangible, computer-readable memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 610 and/or the RAM 615. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 640 may permit information from the bus 600 to be displayed on the display 645 in audio, visual, graphic or alphanumeric format. Communication with external devices, such as a printing device, may occur using various communication ports 650. A communication port 650 may be attached to a communications network, such as the Internet or an intranet.

The hardware may also include an interface 655 which allows for receipt of data from input devices such as a keyboard 660 or other input device 665 such as a camera, scanner, mouse, a joystick, a touch screen, a remote control, a pointing device, a video input device and/or an audio input device.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method, comprising:
receiving, from a consumer via a communications network, a selection of a selected retail promotion, wherein the selected retail promotion corresponds to a promoted product and is not limited to a specific retailer;
storing, in a database, the selected retail promotion in association with a consumer-specific identifier for the consumer;
receiving, via a communications network, receipt data, wherein the receipt data includes information indicating that the consumer has purchased a purchased product;
analyzing, by a processor, the receipt data to identify the purchased product;
accessing, by the processor, the database to identify a promoted product that corresponds to the purchased product;
accessing, by the processor, the database to determine a retail promotion that is associated with the identified promoted product and the consumer; and
issuing, to the consumer, a reward having a value that is determined by the retail promotion.

2. The method of claim 1, further comprising:
receiving, via a communications network from a seller of a plurality of promoted products, a plurality of offered retail promotions, each of which corresponds to at least one of the promoted products; and
storing the offered retail promotions in a computer-readable memory.

3. The method of claim 2, further comprising:
presenting, to the consumer via a clearinghouse portal, the plurality of offered retail promotions; and
wherein receiving the selection comprises receiving a selection of one of the plurality of offered retail promotions.

4. The method of claim 1, wherein receiving the receipt data comprises receiving a scanned image file, and the analyzing and accessing comprises:
using optical character recognition to identify product indicia on the receipt; and
comparing the product indicia with data related to the promoted product to confirm that the consumer purchased the promoted product.

5. The method of claim 1, wherein issuing the consumer a reward comprises sending an electronic payment to a financial account holder of the consumer.

6. The method of claim 1, wherein receiving the receipt data comprises receiving an e-receipt, receiving the data via a near field communication, receiving a text message, receiving a purchase confirmation from a transaction card issuer, or receiving a scanned file of a paper receipt.

7. The method of claim 1, further comprising, before receiving the selection from the consumer, presenting the consumer with a plurality of candidate promotions based on the consumer's input of a product category.

8. The method of claim 1, wherein the product is a pharmaceutical, and the method further comprises, before receiving the selection:
determining that the consumer is eligible to receive a candidate promotion; and
presenting the candidate promotion to the consumer for selection.

9. The method of claim 8, further comprising:
determining that the consumer has previously purchased the pharmaceutical;
determining a refill time; and
communicating a reminder to the consumer within a threshold period of time before the refill time, wherein the reminder comprises a reminder to refill a prescription for the pharmaceutical; and
wherein presenting the candidate promotion comprises presenting a promotion for the pharmaceutical.

10. The method of claim 1, further comprising verifying that the retail promotion is satisfied by comparing supporting receipt data with baseline promotion data, wherein the supporting receipt data comprises a store identifier and an item identifier or name.

11. The method of claim 1, further comprising:
receiving, from the consumer, a product category; and
accessing, by the processor, the database to identify at least one candidate promotion based on the product category;
wherein the selected retail promotion comprises at least one of the candidate promotions.

12. The method of claim 1, further comprising, before issuing the reward:
sending a verification request to a financial institution; and
issuing the reward only after receiving a verification response from the financial institution

13. A retail promotion management system, comprising:
one or more data storage facility portions storing a consumer-specific identifier for a consumer, and a plurality of candidate retail promotions that are associated with the identifier; and
a computer-readable memory containing programming instructions that, when executed, are configured to cause a processor to:
receive, from the consumer, a selection of at least one of the candidate promotions;
receive, via a communications network, receipt data, wherein the receipt data includes information indicating that the consumer has purchased a purchased product;
analyze the receipt data to identify the purchased product;
access the database to identify a promoted product that corresponds to the purchased product;
access the database to determine a retail promotion that is associated with the identified promoted product and the consumer; and
issue, to the consumer, a reward having a value that is determined by the retail promotion.

14. The system of claim 13, wherein:
the memory contains additional programming instructions that, when executed are configured to instruct the processor to:
receive, via a communications network, a plurality of offered retail promotions, each of which corresponds to at least one of the promoted products,
store the offered retail promotions in a computer-readable memory, and
present, to the consumer via a clearinghouse portal, the plurality of offered retail promotions;
wherein receiving the selection comprises receiving a selection of one of the plurality of offered retail promotions.

15. The system of claim 13, wherein:
the programming instructions that cause the processor to analyze the receipt data comprise instructions to identify product indicia in the receipt data; and
the memory contains additional programming instructions that, when executed are configured to instruct the processor to compare the product indicia with data related to the promoted product to confirm that the consumer purchased the promoted product.

16. The system of claim 13, wherein the memory contains additional programming instructions that, when executed, are configured to instruct the processor to:
determining that the consumer is eligible to receive a candidate promotion; and
present the candidate promotion to the consumer for selection.

17. The system of claim 13, wherein the product is a pharmaceutical and the memory contains additional programming instructions that, when executed, are configured to instruct the processor to:
determine that the consumer has previously purchased the pharmaceutical;
determine a refill time; and
communicate a reminder to the consumer within a threshold period of time before the refill time, wherein the reminder comprises a reminder to refill a prescription for the pharmaceutical; and
wherein presenting the candidate promotion comprises presenting a promotion for the pharmaceutical.

18. The system of claim 13, wherein the memory contains additional programming instructions that, when executed are configured to instruct the processor to verify that the retail promotion is satisfied by comparing supporting receipt data with baseline promotion data, wherein the supporting receipt data comprises a store identifier and an item identifier or name.

19. The system of claim 13, wherein the memory contains additional programming instructions that, when executed are configured to instruct the processor to:
receive, from the consumer, a product category; and
access the database to identify at least one candidate promotion based on the product category;
wherein the selected retail promotion comprises at least one of the candidate promotions.

20. A method, comprising:
receiving, via a communications network, a plurality of offered retail promotions, each of which corresponds to at least one promoted product;
presenting, to the consumer via a clearinghouse portal, the plurality of offered retail promotions;
receiving, from the consumer via a communications network, a selection of a selected retail promotion, wherein the selected promotion is not limited to a specific retailer;
storing, in a database, the selected retail promotion in association with a consumer-specific identifier for the consumer;
receiving, via a communications network, receipt data, wherein the receipt data includes information indicating that the consumer has purchased a promoted product;
analyzing, by a processor, the receipt data to identify the purchased promoted product;
accessing, by the processor, the database to determine a retail promotion that is associated with the purchased promoted product and which has been selected by the consumer; and
issuing, to the consumer, a reward corresponding to the retail promotion.
